(19) United States
(12) Patent Application Publication
(10) Pub. No.: US 2020/0282763 A1
(43) Pub. Date: Sep. 10, 2020

(54) Dice Pen A Pen With A Compartment for Dice Storage and Transport

(71) Applicant: Quentin Bruins, Holland, MI (US)

(72) Inventor: Quentin Bruins, Holland, MI (US)

(21) Appl. No.: 16/293,952

(22) Filed: Mar. 6, 2019

(51) Int. Cl. B43K 29/00

(52) U.S. Cl. CPC B43K 29/002

(57) ABSTRACT

A means of representing improved form of pen assembly which embodies a structure where the body is used to hold the dices which allow the user to play the dice games at any spot whereas using the pen nib for its conventional use and writing the scored points.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present disclosure relates to writing instruments and more particularly relates to a multi-functional pen input device which not only provides an exclusive writing experience but can also hold the dice in its body to play dice games and write the scores with pen.

### DESCRIPTION OF THE RELATED ART

The main flaws of quills and pens with no ink reservoir is that they must be constantly dipped in ink so they could write or draw and, because of that, they can very easily stain the surface on which they write. Fountain pen is the first solution for these problems. It has a reservoir in its body which holds water-based liquid ink for longer writing. This ink passes through a feed to the nib under the influence of gravity and capillary action. Fountain pen can be filled with ink in different ways, depending of the way it is built: with a pipette or syringe, with its own filling mechanism that works like a piston or by placing a cartridge filled with ink inside its body. Some rare models hold in their body ink tablets that are dissolved in water and then poured in the fountain pen.

Earliest mention of a pen that has an ink reservoir is from year 973. Mead. al-Mu'izz, the caliph of the Maghreb, region of Northwest Africa, asked for a pen that would keep his hand clean while he uses it and would not leave as much mess as standard pens and quills. His wish was fulfilled with a pen that held ink inside and could be held upside-down without spilling but we don't know precisely how this pen worked or how it looked like. Next mention of a pen with inner reservoir comes from 17th century and then till day multiple types of fountain pen have come into the market each holding a unique functionality to assist the user.

For instance U.S. Pat. No. 2,008,003,048,6 issued to QuiteSo Tech LLC displays, a multi-function pen input device is disclosed which includes a conventional pen input device for use on a paper medium, such as a ball. point pen and/or a pencil lead feeder, and an active stylus for use with a paperless medium, carried in a single housing which includes a cap portion and a barrel portion. Unlike known pen input devices, the multi-function pen input device in accordance with the present invention can be used with electronic devices that include a digitizing tablet. In one embodiment of the invention, the multi-function pen input device further includes an electronic circuit that enables it to be used as pen input device for virtual writing surfaces and transmit signals to a remote PC. In all embodiments, a cam arrangement is provided that selectively and alternatively allows the ball point pen and/or pencil lead feeder as well active stylus to be placed in a use position, for example, by way of a relatively simple twist of the cap portion with respect to the barrel portion.

Moreover according to U.S. Pat. No. 3,594,091 issued to Keith T Bleuer is a ballpoint pen using liquid ink including a pen housing, an ink cartridge, and ball-carrying plunger assembly reciprocably movable in the housing so that the ball and assembly may be moved forwardly to protrude from the housing, a disc of rubberlike material having a central perforation therethrough and located internally and at the forward end of the housing through which the ball and assembly may be moved and forming an ink seal when the ball and assembly is in retracted position in the housing, and selectively operable means at the other end of the housing for selectively moving the cartridge and ball assembly forwardly in the housing and holding it in such a position.

In U.S. Pat. No. 3,003,182 issued to Speedry Chemical Products Inc is a product which replaces a nib by one having a different shape, such as a round end, square end, chisel-shaped end or pointed end. It is also the objects of the present invention is to provide a pen of the type indicated in which nibs of different shapes are carried by nib embracing adapters and which may be easily and quickly interchanged by merely sliding the nibs and thin adapters into and out of the nib holder.

From all of the prior art work studied, it has been found that none of the invention has been disclosed which has the feature of pen and dice holder. The pen will provide the utility of playing any dice game and then writing the score at same point.

Thus it has been noted, to Applicant's knowledge, none of these prior art methods have been found to be completely suitable to meet these needs and are cumbersome, Thus, there is a need in the prior art in which the aforementioned inconveniences, difficulties, and grooming problems are, for all practical purposes, eliminated. Thus, the present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A. full appreciation of the various aspects of the invention can be gained by taking the entire specification, claims, drawings, and abstract as a whole.

A prime objective of the present invention is to provide an improved form of a fountain pen which holds the dice within its body

It is further the objective of the present invention to provide a pen where the dice can be taken out from the body of pen and can be used to play dice games at any point of time

Another very important object of the instant invention is the provision of ting the scores with the pen while playing the game with partners.

The further objective of the invention is the pen which is ornamentally designed, has a good appearance, and it is durable, lightweight, compact in packaging and convenient in carrying.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a front view of the present disclosure.

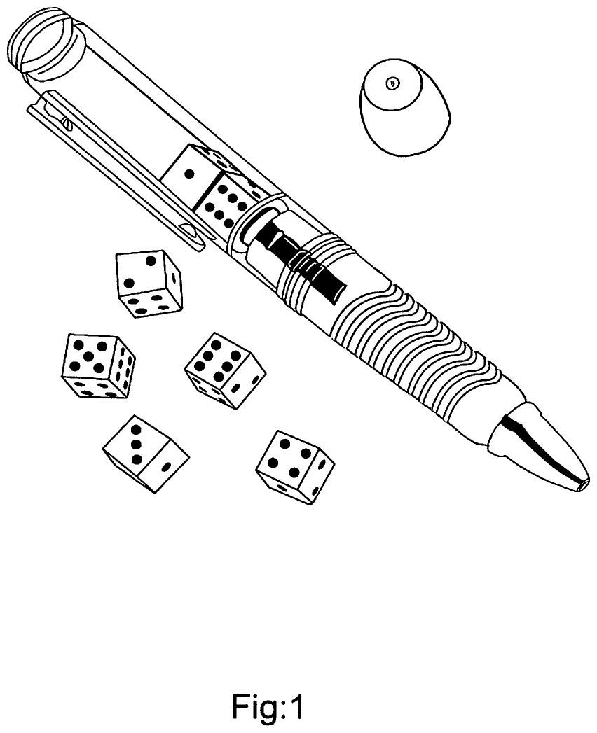

FIG. 2 displays the view of pen body where dices are secured.

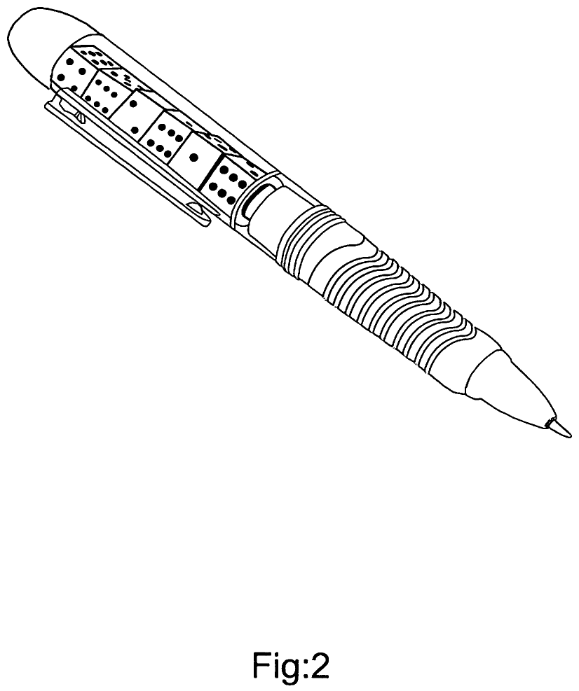

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before explaining the invention in detail, it is to be understood that the invention is not limited in its application to the detail of application illustrated in the drawings since the invention is capable of other embodiments and of being practiced or carried out in various ways. It is also to be understood that the phraseology or terminology employed is for the purpose of description only and not of limitation.

Writing instruments designed to carry their own supply of ink had existed in principle for over 100 years before Waterman put his mind to improving the concept. The earliest inventors noted the apparent natural ink reserve found in the hollow channel of a bird's feather. They tried to produce a similar effect, creating a man-made pen that would hold more ink and not require constant dipping into an inkwell. But a feather is not a pen, and filling a long thin reservoir made of hard rubber with ink and sticking a metal ‘nib’ at the bottom was not enough to produce a smooth writing instrument.

The oldest known fountain pen—still around today—was designed by M. Bion, a Frenchman, in 1702. Till date multiple types of pen have been brought into the market serving in its own domain for the betterment of writing experience.

With the advent of technology and fast pace world people always want to utilize their time effectively. They always want a product which gives them the maximum input with additional benefits. If you are at home or outdoor with children spending quality time, pen is an accessory which is always in pocket. More or less every second individual is holding pen in pocket or females are carrying them in their hand bags.

The current invention embodies a structure which serves the purpose of conventional ball point with the advanced feature of dice holder encased in a transparent structure stretching from the front end to rear end of the pen.

The invention in its preferred embodiment shows a pen which has dice in its posterior part of the body and can hold standard regular dice for playing any normal dice game but also specialty dice. The +1, +2, +3, −1, −2 & −3 dice can be used in card games like Magic and the Gathering games. It has to be noted further that other type of dices are also intended to make with diagrammatic figures on then or in multiple shapes and sizes to provide a wide range of dices to the user.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: The invention is a Dice Pen where it consist of an elongated structure, with a fluent ink cartridge assembly presented within the said casing and having a forward end portion extending from the front end of casing and providing a writing point, where the said assembly having a rear part where the rear casing of assembly holding multiple dices to facilitate the user playing any dice game whereas the front end having a nib at the front portion allowing the user to note down the score
A dice pen according to claim 1, where said writing instrument consist of a front nib to provide the writing assembly
A dice pen according to claim 1, where a transparent assembly securing dice extending from front end to the rear end is present
A dice pen according to claim 1, where said cartridge assembly being cylindrical at its rear end and said piston constituting the round rear end of said cartridge assembly
